(19) United States
(12) Patent Application Publication
(10) Pub. No.: US 2007/0092114 A1
(43) Pub. Date: Apr. 26, 2007

(54) Method, communication system and remote server for comparing biometric data recorded with biometric sensors with reference data

(75) Inventors: Rudolf Ritter, Zollikofen (CH); Eric Lauper, Bern (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/586,158

(22) Filed: Oct. 25, 2006

(30) Foreign Application Priority Data
Oct. 26, 2005 (EP) EP05110041

(51) Int. Cl. G06K 9/00

(52) U.S. Cl. 382/115

(57) ABSTRACT

A method, a communication system and a remote server (6, 7) are disclosed for comparing biometric data recorded with different biometric sensors (1.3, 8) with reference data. In the inventive method, biometric data are recorded by the biometric sensor (1.3, 8). Simultaneously, the type of sensor is determined and sensor-dependent parameters are determined depending on the type of the sensor (1.3, 8) outside the sensor (1.3, 8). The recorded biometric data are compared with reference data, whereas for the comparison the parameters dependent on the sensor (1.3, 8) are taken into account. Advantageously, a comparison of biometric data that have been recorded with sensors (1.3, 8) from different manufacturers is possible easily and reliably.

### REFERENCE DATA

This application claims priority from European patent application 2005EP-110041 of Oct. 26, 2005, the contents whereof are hereby incorporated.

1. Technical Field

The invention relates to a method, a communication system and a remote server for comparing biometric data recorded with biometric sensors with reference data according to the independent claims.

2. State of the art

Biometric sensors are already known in the prior art. These biometric sensors are generally used for biometric identification or authentication within security-relevant systems or applications. In the case of these applications, there is however the problem that different manufacturers of biometric sensors supply other biometric data or sets of data for the same biometric features. It follows from this that biometric reference data always have to be recorded with the same type of sensor so that they can later be compared with biometric data recorded by the user since the format is then the same. This is however unfortunately not always possible because different components are always involved. For example, different mobile telephones have implemented fingerprint sensors from different manufacturers. If a reference fingerprint is taken in a shop for a service and the sensor is different from the sensor in the mobile device, security is not guaranteed because of said problem. If the reference data are compared with the biometric data, it can lead to misinterpretations. The user could also not easily exchange his mobile telephone (e.g. by buying a new one or by using the telephone of an acquaintance), since the data would then no longer be compatible.

WO-A1-01/33494 offers for this reason a standardization of the biometric data. This adaptation is however not made depending on the type of sensor, but refers only to the recorded biometric data as such.

WO-A2-02/44999 discloses a method for determining an error rate for a biometric installation. In order to determine the error rate, a current biometric feature of an authorized person is tested against a number of biometric features of strangers and the error rates are determined through the frequency of access being granted for an unauthorized person and the frequency of access being refused for an authorized person. In the biometric installation, a test run is carried out by using a database containing a number of feature sets of strangers and comparing these feature sets of strangers with the set of features of a stored current feature of the authorized person and from there determining personal error rates for the authorized person.

EP-A2 116072 also discloses a biometric standardization method for determining error rates.

US-A1-2004/104807 discloses an authentication through biometric fingerprint sensors that are connected with a central server. Since sensors from different suppliers can be used, the server first determines the type of sensor, then sends control and optimization parameters to the sensor and determines the user's biometric data. The biometric data thus determined are compared with the reference data. The disadvantage, however, is that it is not possible to compare the biometric data with the reference data without adapting the sensor.

US-A1-2002/0108047 describes a system for converting the resolution of an image of a fingerprint and making it available to a comparison unit.

### REPRESENTATION OF THE INVENTION

It is an aim of the invention to propose a method, a communication system and a remote server for comparing biometric data recorded with biometric sensors with reference data.

According to the invention, this aim is achieved through the independent claims.

In particular, this aim is achieved with a method according to the independent claim characterized by the following method steps:

(a) biometric data are recorded by the biometric sensor,

(b) the type of sensor is determined,

(c) sensor-dependent parameters are determined depending on the type of sensor outside the sensor and

(d) the recorded biometric data are compared with reference data, whereas for the comparison the sensor-dependent parameters are taken into account.

The inventive aim is also achieved with a communication system for comparing biometric data recorded with different biometric sensors with reference data, said communication system consisting of:

(a) a local device that is connected with a biometric sensor for recording biometric data of the user, and

(b) a remote server in which the sensor-dependent parameters are stored that are taken into account for comparing the recorded biometric data with biometric reference data, whereas

(c) data can be exchanged between the local device and the remote server.

The comparing of biometric data that have been recorded with sensors from different manufacturers are easily and reliably possible.

The recorded biometric data (direct biometric data, a template generated from them or a hash value derived from the template) are standardized in a first step with the sensor-dependent parameters and the standardized biometric data are compared in a second step with the biometric reference data. During standardization, at least one of the following values such as resolution, image size and image file format are adapted, whereas a geometric equalization, vignetting correction, noise suppression and adjustment of sharpness can be used.

It is also possible to use a comparison algorithm to determine the probabilities that the recorded biometric data correspond to every possible biometric reference data, with the comparison algorithm taking into account the sensor-dependent parameters. The comparison algorithm can for example be a Viterbi algorithm in which the probabilities are weighted with said sensor-dependent parameters. It would also be possible to weight these probabilities with sensor-dependent parameters of the sensor with which the biometric reference data were recorded.

As a variant embodiment, it is also possible for the comparison to use instead of or in addition to the Viterbi algorithm a neuronal network in which the nodes are weighted with said sensor-dependent parameters of the recording sensor or of the reference sensor. In a further variant embodiment, it is also possible to use Hidden Markov Models (HMM) where the structure of the model and/or the probabilities of a transition are dependent on these parameters. It is also possible for the Viterbi algorithm, the HMM model and/or the neuronal network to be automatically adapted, e.g. on the basis of the Baum-Welch algorithm, in order to enable the comparison between the recorded biometric data and the corresponding reference data, even if these data have been recorded with different types of sensors.

The dependent claims present preferred embodiments of the inventive method and communication system.

### SHORT DESCRIPTION OF THE DRAWINGS

The invention will be described in more detail on the basis of the attached figures, in which:

FIG. 1 shows an inventive system for carrying out the method according to the invention, and

FIG. 2 shows the generation of a standardized value from biometric data recorded by the sensor, here by way of example for a recorded fingerprint.

### WAYS FOR EXECUTING THE INVENTION

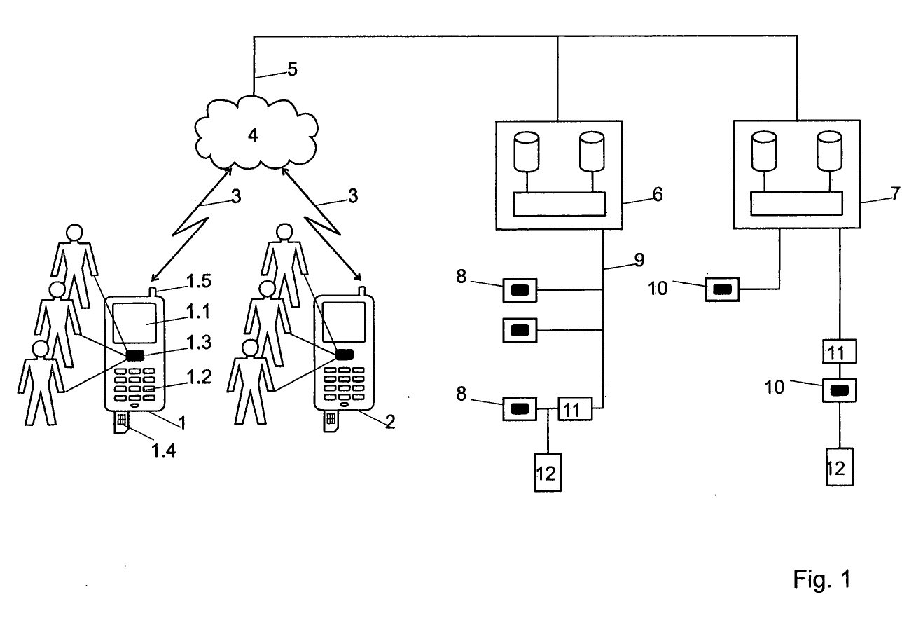

FIG. 1 shows an inventive system suitable for executing the present invention. It is a method for obtaining an access authorization to an object or a service. As a service, it is possible for example to book a hotel room, holiday accommodation or a resource in a building for a particular period of time or to book a ticket for a concert, an exhibition or another event (visiting a disco, gala, cinema, etc.). The present method is advantageously suited for borrowing or pre-ordering other objects (borrowing a bicycle, buying special pre-ordered products, ordering tickets, etc.).

A user is provided with a personal mobile device 1. A series of devices, a mobile telephone, a portable computer, a PDA or a networked play console a suited as mobile device 1 or as mobile station. The mobile device 1 is provided with a display 1.1 and a keyboard 1.2. Simultaneously, a biometric sensor 1.3 is integrated with which a biometric parameter of the user can be recorded. It is obvious that the input means of the mobile device 1 (keyboard, mouse, etc.) can also be provided with such a sensor 1.2 or can function as such a sensor 1.2. It is conceivable within the frame of the invention that the mobile device 1 connects with such a mobile over a wireless interface at close range (IrDA, Bluetoooth, ZigBee, etc.). An additional module that is connected with the mobile device 1 over a wired interface (for example a USB interface) is possible within the frame of the invention.

In the embodiment represented in FIG. 1, the mobile station is a mobile telephone having a SIM card as identification module 1.4 and a mobile antenna 1.5 and integrated in a mobile radio network 4. In the frame of the invention, general communication networks are conceivable, mobile networks such as GSM, GPRS, EDGE, WLAN or UMTS as well as Internet or other fixed networks, as well as connections according to the UMA concept (UMA being the acronym of Unlicensed Mobile Access, e.g. Bluetooth or systems according to the standard 802.11x, see www.umatechnology.org).

According to a first embodiment of the present invention, a user wishing to obtain access to one previously said objects or service has his biometric data (reference parameters) taken by the biometric sensor 1.3 of the mobile device 1 and sent over a communication network to a remote server 6, 7. The remote server 6, 7 is operated by a provider of the object or of the service or by another administrator. The remote server 6, 7 can also be a service server of a network operator (MNO, mobile network operator) or a service server for value added services. In FIG. 1, the transmission occurs for example signed and encrypted over a mobile radio interface 3 and a communication connection 5. The encryption at least of the user's sensitive biometric data further increases the data security of the inventive method and protects against misuse of the transmitted data. Instead of transmitting the original biometric reference parameters to the remote server 6, 7, that the users could possibly not accept, it is possible to compute and transmit a derived form, a so-called template, a signature or a hash value. The same algorithm must then be used when recording in the mobile station of the biometric reference parameters and when recording in the biometric sensor 8, 10 of the object or service provider.

In an advantageous embodiment of the invention, the provider of the object or of the service or another manufacturer offers a software program that the user downloads on his mobile device 1 and with which he proceeds to order and/or which takes over the encryption of the biometric data or also of other transmitted data (booking details, personal data, person-bound code, etc.). Encryption could also be taken over by the SIM card of the mobile station or at least all the keys for the symmetric or asymmetric encryption could be store din the SIM card or in the mobile device. The program can for example be installed as applet on the mobile device 1 merely temporarily during the booking procedure of the object or service. The biometric reference parameters could also be stored on and retrieved from the previously mentioned SIM card of the mobile device 1 or in another memory of the mobile device 1. The downloaded software program can then advantageously revert to the stored data without the biometric data having to be generated each time anew by the generator.

A simple biometric recording can be achieved with a fingerprint sensor as biometric sensor 1.3. Other biometric data such as face, retina, iris or vein recognition, voice analysis, pulse recording, body current recording, etc. are conceivable in the frame of the invention and can be recorded by means of a camera or sensor built in the mobile device 1. For voice recognition, the biometric sensor 1.3 will be a microphone. In order to derive therefrom key data of the user, such as a univocal code, a numeric parameter or a hash code etc., a corresponding software is installed in the mobile device 1 that is tailored to the biometric sensor 1.3 and further processes the recorded data.

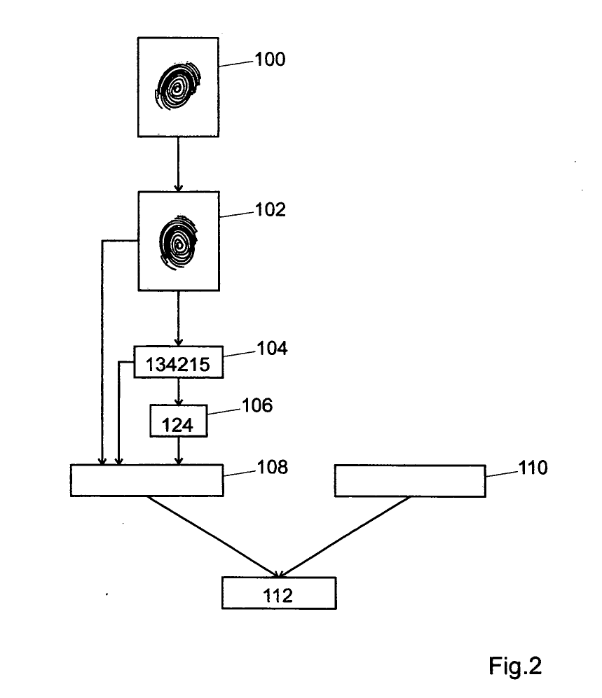

An example for recording fingerprints with said sensors 1.3, 8 are capacitive fingerprint sensors that measure the capacitances between the surface of a silicon sensor and the skin. The measured capacitances are represented in a 8 bit greyscale picture of the recorded fingerprint (see FIG. 2, the fingerprint 100 recorded by the sensor 1.3, 8). After an image of a fingerprint has been recorded, further image processing steps must be performed by the sensor 1.3, 8 before a usable biometric signature can be determined. For this purpose, algorithms for improving the image quality (e.g. high and low pass filters) are used already by the sensor and the image is digitalized resp. standardized in a sensor-internal process (see FIG. 2, standardized fingerprint image 102). Finally, the person-specific features are extracted and the extracted data are stored in a so-called template 104 that corresponds to the above mentioned numeric parameters. For this, a minutiae-based feature extraction for example is an often used method that contains ready-made processing steps (obtaining the greyscale-image, computing the direction field, extracting the foreground part, filtering out the background part and digitalizing, computing the skeleton with marked minutiae, superimposing the minutiae with the original greyscale image). The minutiae-based feature extraction reduces the problem of comparing two fingerprints to the problem of comparing points or graphs and thus requires considerably less computing capability. From the template or the numeric parameter, a univocal hash value 106 can be generated that can also be used for comparison. Standardized fingerprint image, template or hash value however depend on the type of sensor, the chosen resolution etc., so that these values are standardized according to the invention outside the sensor with the sensor-dependent parameters (FIG. 2, standardized value 108) and this standardized value 108 can be compared with the biometric reference data 110 (FIG. 2, step 112).

Other methods, that have been mentioned above, for determining biometric data, show similar steps and methods for achieving a standardized value 108 that can be used for the comparison 112.

During the event etc., the biometric reference parameter is transmitted from the remote server 6 to a comparison module 11 connected with the biometric sensor 8 of the object or service provider, or the user's actual biometric parameters that have been recorded by the biometric sensor 8 are transmitted to the remote server 6. The comparison of the biometric parameters (reference with actual) can thus be performed without problem on the spot before access to the object is granted.

In order to be able to perform this comparison, in the indicated embodiment, not only are the biometric data recorded but the sensor type is also determined. Depending on the type of the sensor 1.3, 8, parameters dependent on the sensor 1.3, 8 are determined in the remote server 6, 7. The recorded biometric data, i.e. fingerprint image, template or hash value, are compared with the biometric reference data, the parameters dependent on the server 1.3, 8 being taken into account according to the invention for the comparison. The recorded biometric data are standardized in a first step with the parameters dependent on the sensor 1.3, 8 and the standardized biometric data 108 (FIG. 2) are compared in a second step with the biometric reference data 110 (FIG. 2, comparison 112). During standardization, at least one of the following values: resolution, image size and image file format, can be adjusted, whereas a geometric equalization, vignetting correction, noise suppression and adjustment of sharpness can be used.

The inventive method also provides that the recorded biometric data are linked with other identification data of the user or of the device 1 that can be read from a chip or SIM card 1.4. This is described further below in one embodiment.

It is also possible to use a comparison algorithm to determine the probabilities that the recorded biometric data correspond to all possible biometric data, the comparison algorithm taking into account sensor-dependent parameters. The comparison algorithm can for example be a Viterbi algorithm in which the possibilities are weighed with said sensor-dependent parameters. It is also possible for these possibilities be weighted with sensor-dependent parameters from the sensor with which the biometric reference data have been recorded.

As a variant embodiment, it would also be possible to use for the comparison instead of, or in addition to, the Viterbi algorithm a neuronal network where the nodes are weighed with said sensor-dependent parameters of the recorded sensor or of the reference sensor. As a further variant embodiment, Hidden Markov Models (HMM) could also be used where the structure of the model and/or the probabilities of a transition depend on these parameters. It is also possible for the Viterbi algorithm, the HMM model and/or the neuronal network to be adapted automatically, e.g. on the basis of the Baum-Welch algorithm, in order to make possible the comparison between the recorded biometric data and the corresponding reference data, even if these data have been recorded with different sensor types.

The transmitted biometric reference data can also be stored in standardized form, a format having to be previously defined. It is also conceivable that the biometric reference data and parameters from the sensor with which the reference data have been recorded are stored. In this fashion, the format of the biometric reference data is set.

In one embodiment, the remote server 6 is connected to a hotel management system. The user sends to the remote server 6 his booking details, such as date of arrival and departure, number and selection of the rooms, number of the meals, etc. which he enters for example in the applet, together with the biometric data from his personal mobile device 1. Simultaneously, personal data such as name, address, billing details can be transmitted, inasmuch as these are not yet available in the remote server 6. The remote server 6, after receiving the message and performing the booking accordingly, sends back to the personal mobile device 1 a confirmation message that for example includes the room or seat number or other particulars. On the basis of the above mentioned communication network, a plurality of messages are possible for the booking and the confirmation message: SMS, MMS, USSD, e-mail, WEB or WAP page etc. can be used without problem.

For the duration of use of the hotel room or of the holiday accommodation, the biometric reference parameters or the user's key data derived therefrom from the remote server 6 are connected logically with a biometric sensor 8. The biometric sensor 8 is located on the hotel room door or on the door of the holiday accommodation. Different biometric sensors 8 can of course be found on different doors leading to the same or to different objects. The user can thus in addition to his room simultaneously book access to a fitness room, a sauna or an underground car park. The user can be authenticated with the biometric sensor 8 through recording the actual biometric parameter and comparing it with the data stored in the remote server 6 and can gain access to the object or service. The biometric sensor 8 is connected to this effect with a module 11 for comparing stored biometric reference parameters and recorded actual parameters. The mentioned standardization of the recorded biometric data occurs as described above with parameters determined depending on the type of sensor in the remote server 6, 7. Simultaneously, the biometric sensor 8 is connected with means 12 that control access to the room door (or to another object). The user advantageously no longer needs to register at reception since all data of the user are already available in the remote server 6 of the hotel management system and the user has already received the room number, day of arrival, time of the breakfast buffet etc. in the confirmation message from the server 6. It is important in this connection to note that the recording of the biometric reference parameters and the recording of the actual biometric parameters are made by two different sensors.

If holiday accommodation is booked for the whole family with the same system, the main user can define a group 2 in his mobile device 1 and store the biometric reference parameters of all family members in this group 2. Upon booking, the biometric data of the group 2 are transmitted to the remote server 6. During the holiday, the data of all family members are stored in said remote server 6. Each family member thus obtains an individual access authorization for the holiday accommodation, without having to ask separately for a key at reception or having to register. The main user in this case is responsible vis-a-vis the hotel or the renter of the holiday accommodation for the bill for the whole group 2, his family, his work colleagues, the members of the group 2. The advantage is that the other people authorized to do so can access the booked objects or services without personal mobile station.

According to the same principle, a sequence of fingerprints or other biometric features can be recorded as biometric parameter. If the error rate for the incorrect acceptance of a non-authorized finger lies at 10⁵, this error rate falls to 10¹⁰ for a sequence of two fingers or other biometric features.

In the second embodiment, represented in FIG. 1, a remote server 7 is part of a concert organizer or an organization supplying tickets for concerts, gala events, cinema performance Again, the user sends through his personal mobile device 1 a message with all booking data, concert, name of the group 2, cinema film, etc. together with his personal biometric reference parameters encrypted to the remote server 7 in order to perform a booking. The remote server 7 stores the data and sends a confirmation message to the user in the described manner. On the day of the concert, the user's personal data (biometric reference parameters) are connected by the remote server 7 over a local connection 9 or another communication connection with the biometric sensors 10 and stored in a comparison module 11. It is also conceivable that the actual recorded biometric parameters are sent by the biometric sensor 11 to the remote server 7. The sensors 10 are placed at the entrance to the cinema or the concert hall. The visitor to the event is authenticated at the entrance through the biometric sensor 10 by recording the biometric parameters and comparing them with the stored data, and thus gains access to the event he booked. In combination with the input of a single code such as for example a seat number during entry of the actual biometric parameter, the identity of the person authorized to access is merely verified, which simplifies the complexity of the checking.

In an advantageous variant embodiment of the inventive method, different access rights to different objects or services can be allocated in the inventive method to different fingers of the user. For security and data protection reasons, after the end of the duration of use of the object or the duration of the service, the biometric reference parameter or the key data derived therefrom of the user can be deleted from said remote server so that no misuse can occur with the biometric data.

In a second embodiment of the invention, when ordering, a further person-bound code is transmitted additionally with the details of the order to the remote server 6, 7. This could be the telephone number or another code stored in the mobile station. This can be for example the sensor ID, the IMEI, the IMSI, a PIN, an EPIN etc. Before the vent, etc. the user goes to the place of the event and is authenticated at a biometric sensor 8, 10 found on the object or at the service and that is connected with the means 12 that control access. The biometric reference parameter stored in the mobile station is transmitted over a contactless interface at close range (Bluetooth, IrDA, ZigBee, NFC (RFID), etc.) from the mobile station to a comparison module 11 connected with the biometric sensor. The biometric sensor records the user's actual parameters and the biometric reference parameter is compared with the actual parameter in the comparison module 11 in the inventive fashion. Additionally, the person-bound code that was indicated when ordering is transmitted by the remote server 6, 7 to the comparison module 11 connected with the biometric sensor or by the comparison module 11 to the remote server 6, 7. The comparison of the biometric parameters and of the person-bound code can thus be performed without problem on the spot before access to the object is granted.

In the same manner, it is also possible to pre-order things. If a user with his family wishes to rent bicycles, he books the bikes in advance in the fashion described here and is identified with a biometric sensor in a shop or has access to the objects that are stored in a certain, closed location (bicycle shed, garage, etc.). The garage is also locked with a biometric sensor. The booking of other objects is also possible through the inventive method. The user can book a ticket and instead of queuing a long time at the desk, he can be authenticated biometrically at an automatic machine and the ticket is printed by the automatic machine. This can be done without waste of time directly before departure of the train. In the same manner, a ski lift can be checked, the ski pass being pre-ordered electronically in the described fashion and the authenticating occurring before getting on. A turnstile or another access restriction to the lift is only released if the biometric authentication of the use is positive.

Temporary access to the object or service can be billed over the telephone bill, over a prepaid account or over a credit card of the user. The user could open his own account with a ticket agency or with the hotel over the internet or the mobile telephone and indicate in this account the billing mode (credit card, prepaid, monthly bill, etc.). By logging into this account, he can at any time have an overview over made and expired bookings or incurred costs. When the user transmits the booking to the organizer or service provider, the user's account is in this case also simultaneously debited in the manner he selected. The bill could of course also be made over the telephone bill of a mobile telephone subscriber. In this case, the costs are collected by the telephone company and forwarded to the organizer or service provider.

The present invention also relates to a communication system for comparing biometric data recorded with different biometric sensors 1.3, 8 with reference data, having the device characteristics indicated in the description. The inventive method and system advantageously allows an easy and reliable comparison of biometric data recorded with sensors from different manufacturers. A central, permanent storage of the biometric is advantageously not provided.

### LIST OF REFERENCES

1 Mobile device
1.1 Display
1.2 Keyboard
1.3 Biometric sensor
1.4 Identification module
1.5 Mobile antenna
2 Group
3 Mobile radio interface
4 Mobile radio network
5 Communication connection
6 Remote server
7 Remote server
8 Biometric sensor
9 Local connections
10 Biometric sensor
11 Comparison module
12 Means for controlling access to the object or service
100 Fingerprint recorded by the sensor
102 Standardized fingerprint image
104 Template
106 Hash value
108 Standardized value
110 Biometric reference data
112 Comparison standardized value 108 with biometric reference data 110

1. Method for comparing biometric data recorded with different biometric sensors with reference data, with the following method steps:
(a) biometric data are recorded by the biometric sensor,
(b) the type of sensor is determined,
(c)parameters dependent on the sensor are determined depending on the type of the sensor outside the sensor and
(d) the recorded biometric data are compared with reference data,
(e) whereas for comparing the recorded biometric data with biometric reference data, the parameters dependent on the sensor are taken into account.

2. The method of claim 1, characterized in that the recorded biometric data are standardized in a first step with the parameters dependent on the sensor and the standardized biometric data are compared in a second step with the biometric reference data.

3. The method of claim 2, characterized in that at least one of the following values such as resolution, image size and image file format are standardized for the recorded biometric data with the sensor-dependent parameters.

4. The method of claim 2, characterized in that during standardization at least one of the following steps such as geometric equalization, vignetting correction, noise suppression and adjustment of sharpness are used.

5. The method of claim 1, wherein said sensor is connected locally with a device,
wherein said sensor-dependent parameters are stored in a remote server and wherein the remote server is connected with said device for comparing the biometric data.

6. The method of claim 5, wherein the comparison is performed in said remote server and the recorded biometric data are sent to the remote server.

7. The method of claim 5, wherein the comparison is performed locally in said device and said sensor-dependent parameters are sent to the device.

8. The method of claim 5, wherein said biometric reference data are stored in a chip card in said device.

9. The method of claim 1, wherein said sensor extracts numeric parameters from the recorded biometric data and the extracted numeric parameters are used for said comparison.

10. The method of claim 1, wherein a hash is generated from the recorded biometric data and the hash is used for said comparison.

11. The method of claim 1, wherein the recorded biometric data are linked with other identification data of the user or a device of the user.

12. The method of claim 11, wherein said other identification data of the user or of the device are read from the chip card.

13. The method of claim 1, characterized in that the biometric reference data are stored in standardized fashion.

14. The method of claim 1, characterized in that the biometric reference data and parameters from the sensor with which the reference data have been recorded are stored.

15. The method of claim 1, characterized in that a comparison algorithm is used for determining the probabilities that the recorded biometric data correspond to every possible biometric reference data, whereas the comparison algorithm takes into account the parameters dependent on the sensor.

16. The method of claim 15, characterized in that the comparison algorithm uses a Viterbi algorithm in which the probabilities are weighed with said sensor-dependent parameters.

17. The method of claim 15, characterized in that the comparison algorithm uses a Viterbi algorithm in which the probabilities are weighed with sensor-dependent parameters from the sensor with which the biometric reference data have been recorded.

18. The method of claim 1, wherein a sequence of biometric features are compared one after another.

19. The method of claim 1, wherein a fingerprint, an iris, retina or face scan, vein or voice recognition are used as biometric data.

20. A communication system for comparing biometric data recorded with different biometric sensor with reference data, consisting of
(a) a local device that is connected with a biometric sensor for recording biometric data of the user, and
(b) a remote server in which the parameters dependent on the sensor are stored, whereas
(c) between the local device and the remote server data can be exchanged,
characterized in that
(d) the parameters dependent on the sensor are taken into account for comparing the recorded biometric data with biometric reference data.

21. The communication system of claim 20, characterized in that the biometric reference data are stored in the remote server or in the local device.

22. The communication system of claim 20, characterized in that the biometric reference data are stored in the remote server or in the local device.

23. The communication system of claim 20, characterized in that the local device is a mobile telephone with an identification module and the mobile telephone is connected over a mobile radio network with the remote server.

24. The communication system of claim 23, characterized in that the biometric sensor is integrated in the local device or is connected with the local device over an interface at close range.

25. The communication system of claim 20, characterized in that a fingerprint sensor, an iris, retina or face scanner, a vein recognizer or a microphone is available as biometric sensor.

26. Remote server for comparing biometric data recorded with different biometric sensors with reference data, whereas parameters dependent on the sensor are stored in the remote server, characterized in that the dependent parameters are taken into account when comparing recorded biometric data with biometric reference data.
